(19) United States
(12) Patent Application Publication
(10) Pub. No.: US 2003/0061070 A1
(43) Pub. Date: Mar. 27, 2003

(54) Interactive medical training system

(76) Inventors: Gina E. Kelly, Snohomish, WA (US); David R. Levesque, Sammamish, WA (US)

Correspondence Address: ATL ULTRASOUND, P.O. BOX 3003, 22100 BOTHELL EVERETT HIGHWAY, BOTHELL, WA, 98041-3003, US

(21) Appl. No.: 09/963,251

(22) Filed: Sep. 25, 2001

(51) Int. Cl. G06F 17/60

(52) U.S. Cl. 705/2

(57) ABSTRACT

A computer-based medical training system is provided which interactively engages the student. The training system is Web-based and presents the materials being taught in the format of a patient chart familiar to medical professionals, and containing teaching materials such as lab reports, diagnostic images and general medical information not usually found in a case study analysis and patient chart. In a diagnostic medical imaging embodiment the student is presented with information on the full spectrum of diagnostic imaging modalities which may be applied to a given pathology. The training system maintains the interest of the student by providing animated graphics of the principles being taught. The learning of the student is continually validated and reinforced by periodic tests following the teaching of individual lessons within the course of training.

This invention relates to medical training systems and, in particular, to computer-based interactive medical training systems.

Medical personnel have a number of needs for information and education in their fields of medical expertise. Two of these needs are addressed by the present invention. One need is to maintain certification in medical specialties. Many medical specialties such as medical diagnostic imaging require practitioners to take professional training courses in order to maintain certification in their special diagnostic fields. In doing so these specialists continually maintain their knowledge and techniques at state-of-the-art levels, as well as maintain credentials required for their professional positions. Another need is to have current knowledge on state-of-the-art medical equipment and the scientific principles on which they operate. Medical technology is advancing at a rapid rate. As new technologies become available to hospitals and physicians it is imperative that medical professionals become educated on these advances so that they can apply them to their practices and patients.

Traditionally, medical training has been performed through publications, operator manuals, audio and video tapes, and classroom work. With the advent of graphical computer systems and networks, these training materials and techniques have become available on digital media such as CD-ROMs and through networks such as the Internet. These computer-based approaches are capable of providing training and education materials including both text and graphics. These approaches also provide the ability for the student to interact with the educational media. It is desirable that such training not only be instructive, but be attractive so that students find the training to be engaging and enjoyable. Furthermore, such training should be in a realistic form which closely parallels the medical professional's routine medical practice, and should present a breadth of topics which fully cover the diagnostic and treatment options for a particular medical condition.

In accordance with the principles of the present invention a computer-based medical training system is provided which interactively engages the student. In a preferred embodiment the system is Web-based and accessible to users throughout the world. The training system presents the materials in a format which closely simulates the medical records which a medical professional uses in daily practice while providing educational instruction and information not usually found in conventional medical records but which is linked to these materials for teaching purposes. In a diagnostic medical imaging embodiment the student is presented with information on the full spectrum of diagnostic imaging modalities which may be applied to a given pathology. The diagnostic embodiment maintains the interest of the student by providing animated graphics of diagnostic technologies and their principles of operation. The learning of the student is continually validated and reinforced by periodic tests following the teaching of individual lessons within the training course.

In the drawings:

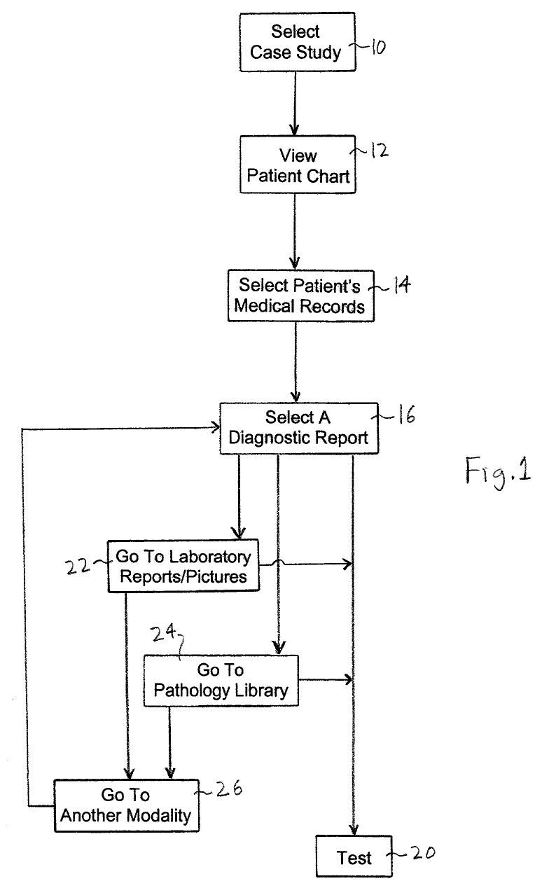

FIG. 1 is a flowchart of the progression of a computer-based medical case study training program organized in accordance with the principles of the present invention;

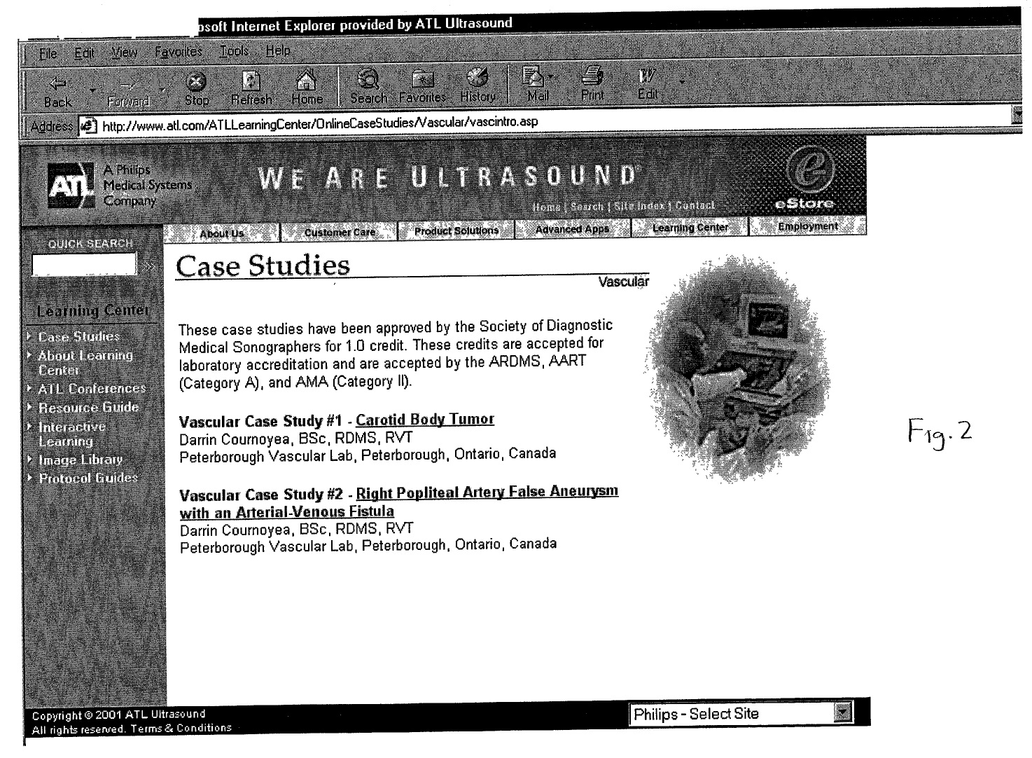

FIG. 2 is a scanned image of a display screen by which a student selects a case study;

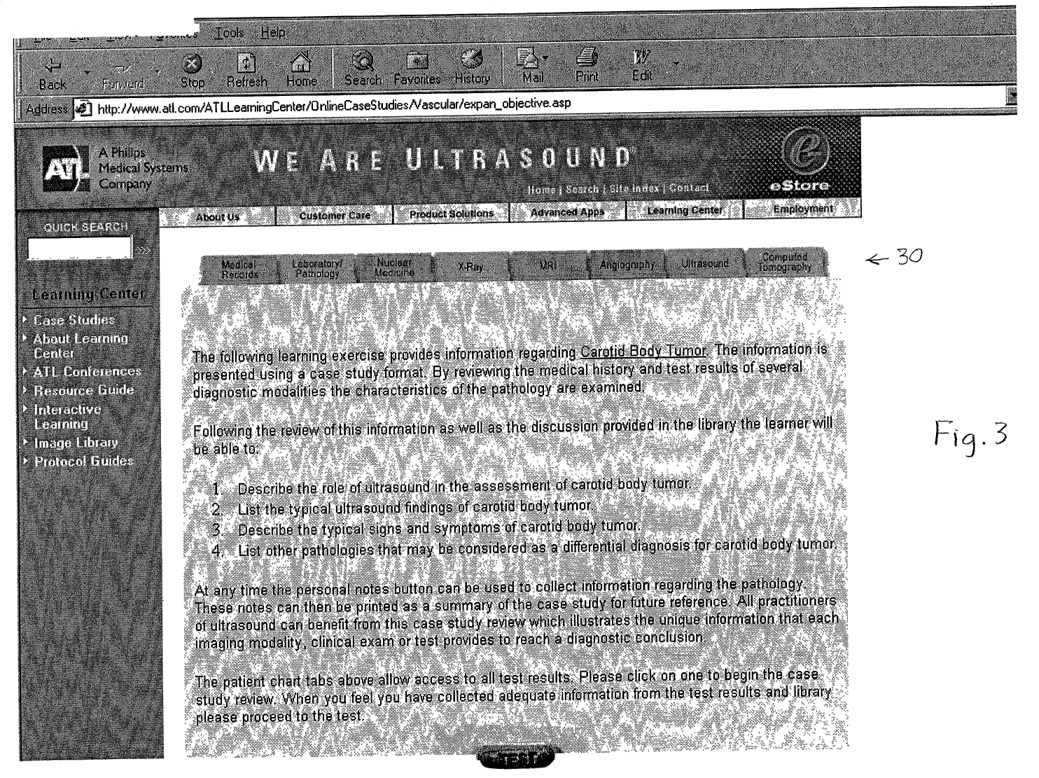

FIG. 3 is a scanned image of a display screen of a virtual patient chart used in a training program of the present invention;

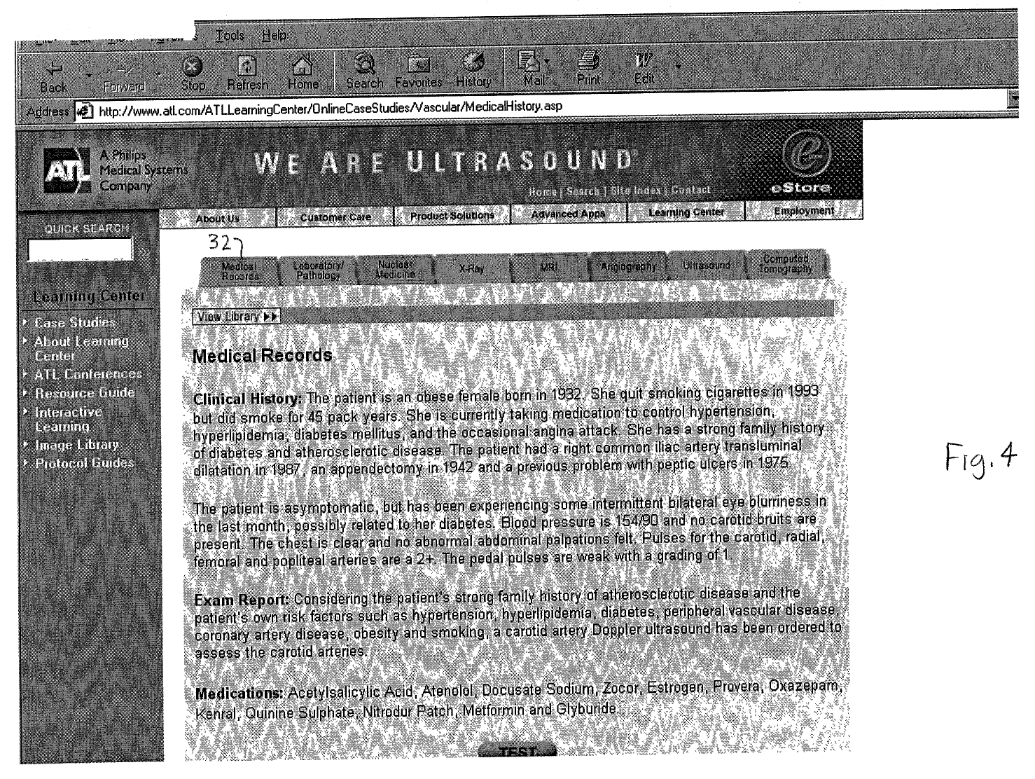

FIG. 4 is a scanned image of a display screen showing the medical records of the patient chart of FIG. 3;

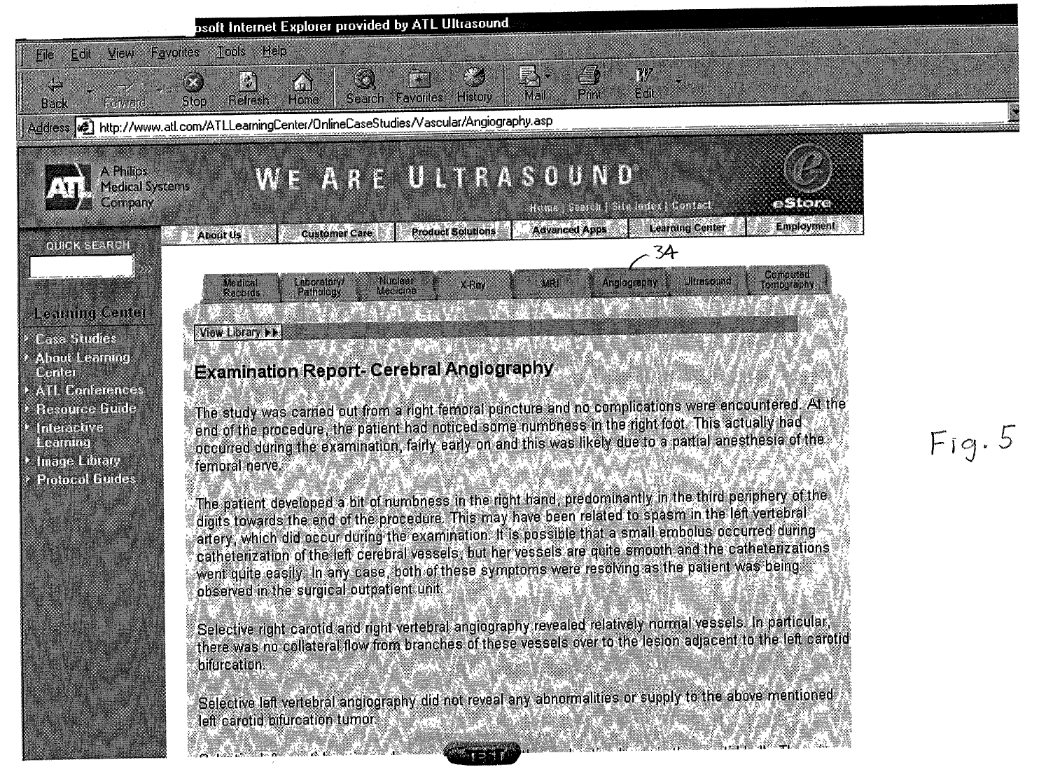

FIG. 5 is a scanned image of a display screen showing one of the diagnostic reports of the patient chart of FIG. 3;

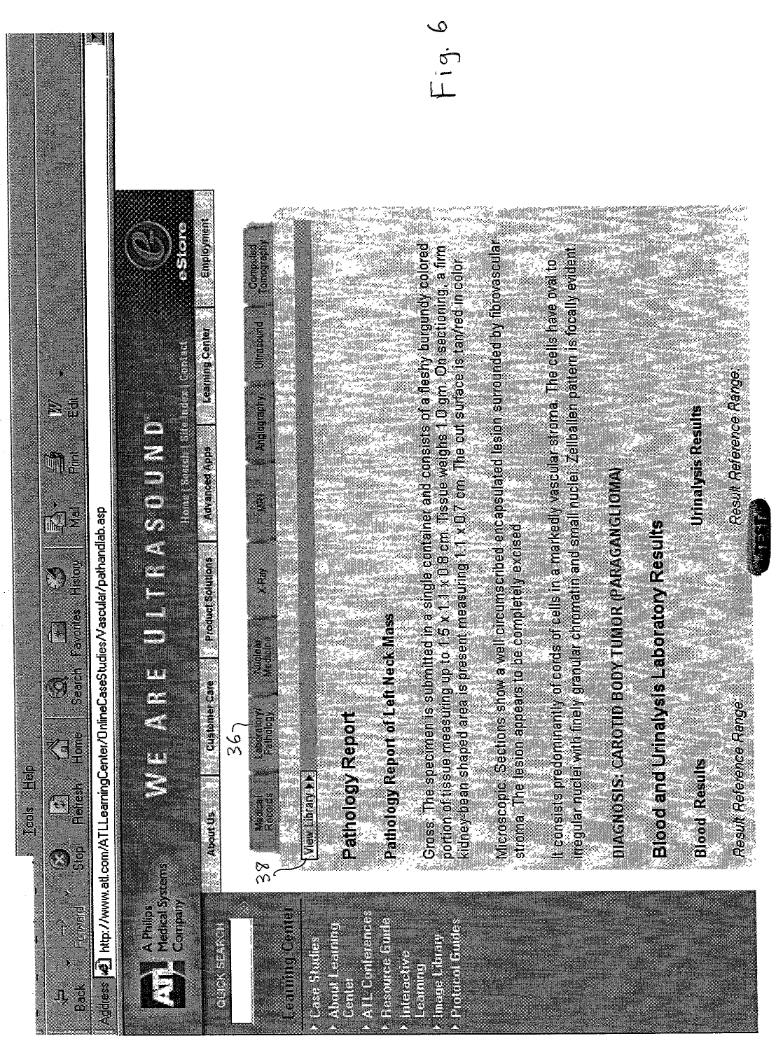

FIG. 6 is a scanned image of a display screen showing a laboratory report of the patient chart of FIG. 3;

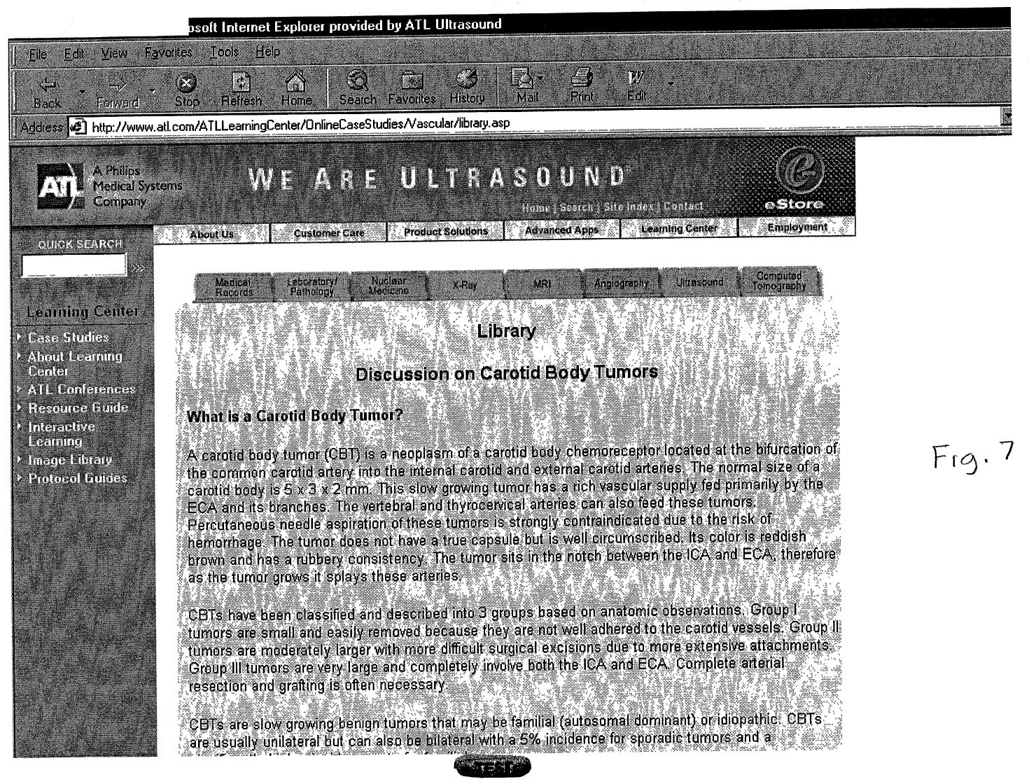

FIG. 7 is a scanned image of a display screen showing the pathology library for the case study of the first embodiment of the present invention;

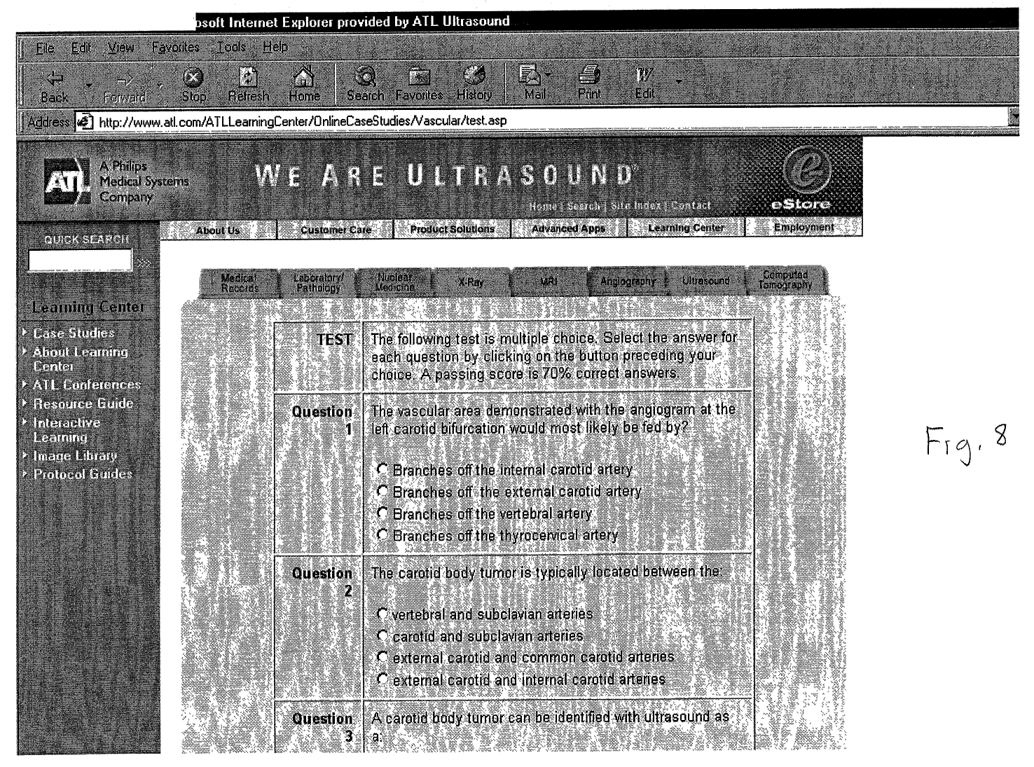

FIG. 8 is a scanned image of a display screen showing the test for the case study of the first embodiment of the present invention;

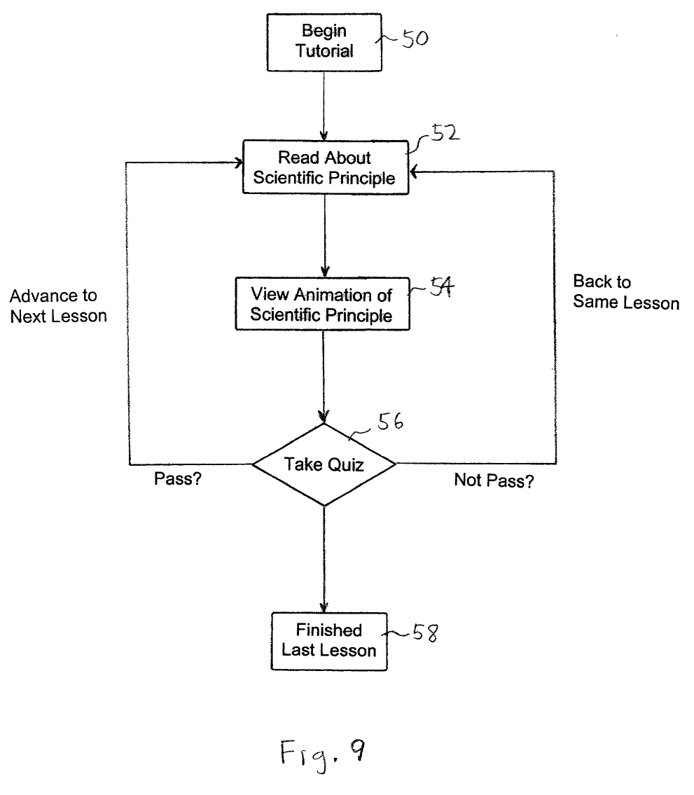

FIG. 9 is a flowchart of the progression of a computer-based medical tutorial training program organized in accordance with the principles of the present invention;

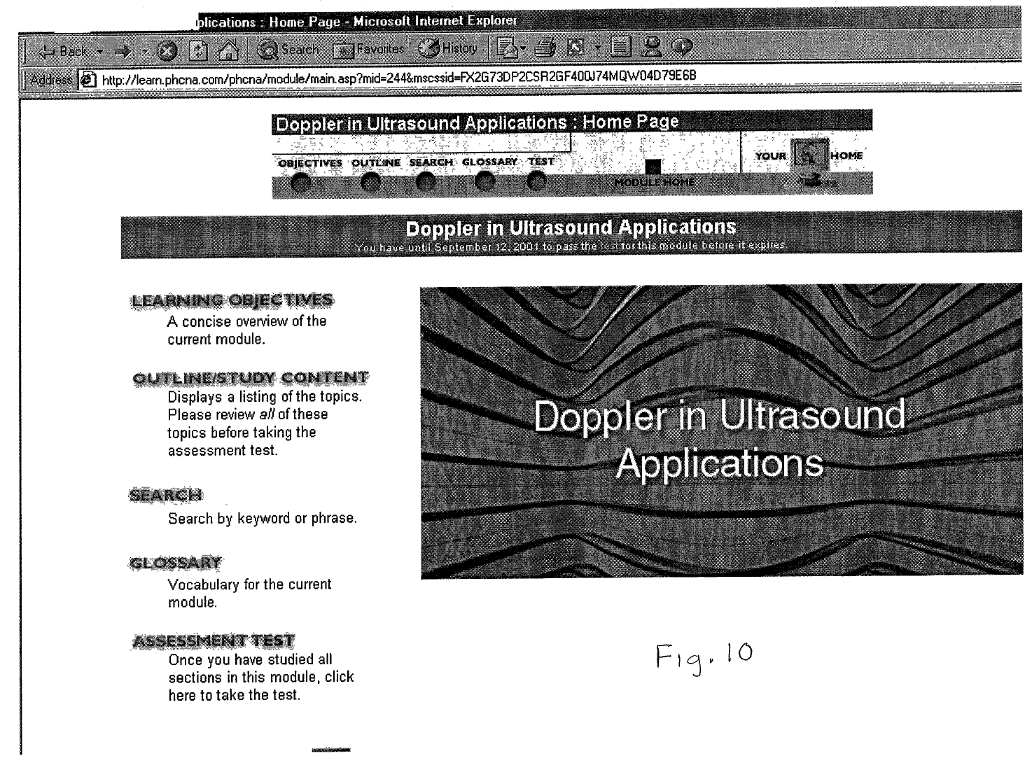

FIG. 10 is a scanned image of a display screen showing the introduction of a tutorial segment on the scientific principle of Doppler as used in diagnostic ultrasound;

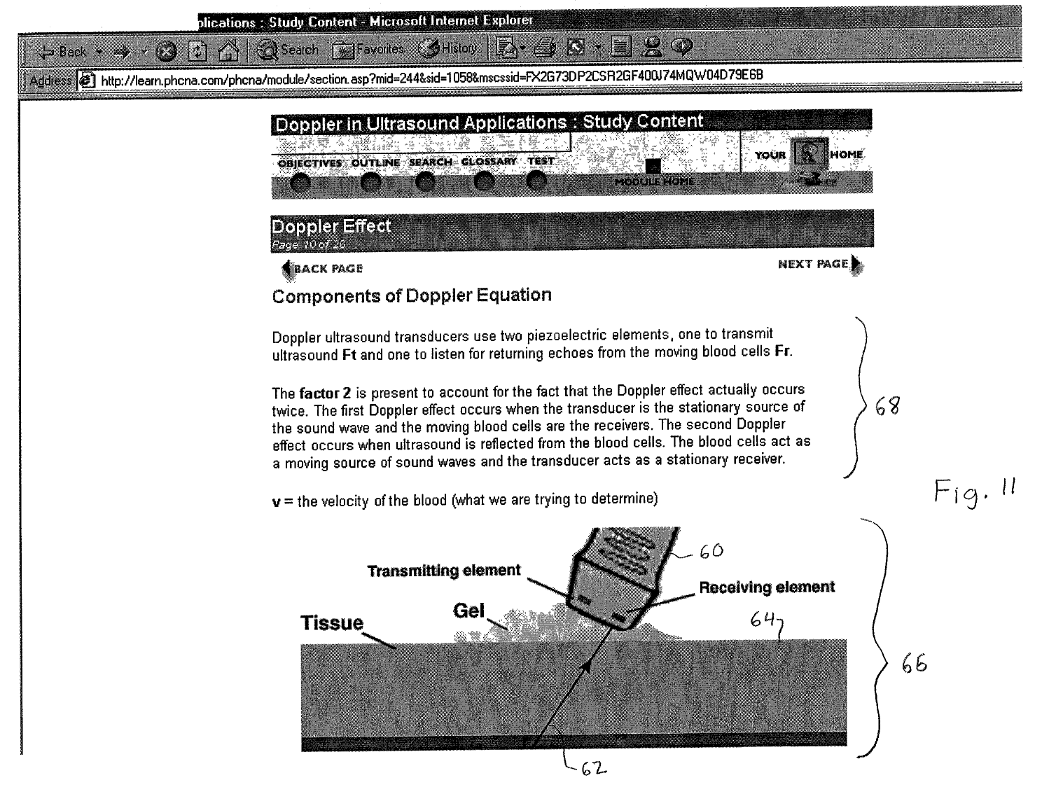

FIG. 11 is a scanned image of a display screen showing a first example of the text and animated graphics for the Doppler segment of the tutorial of a second embodiment of the present invention;

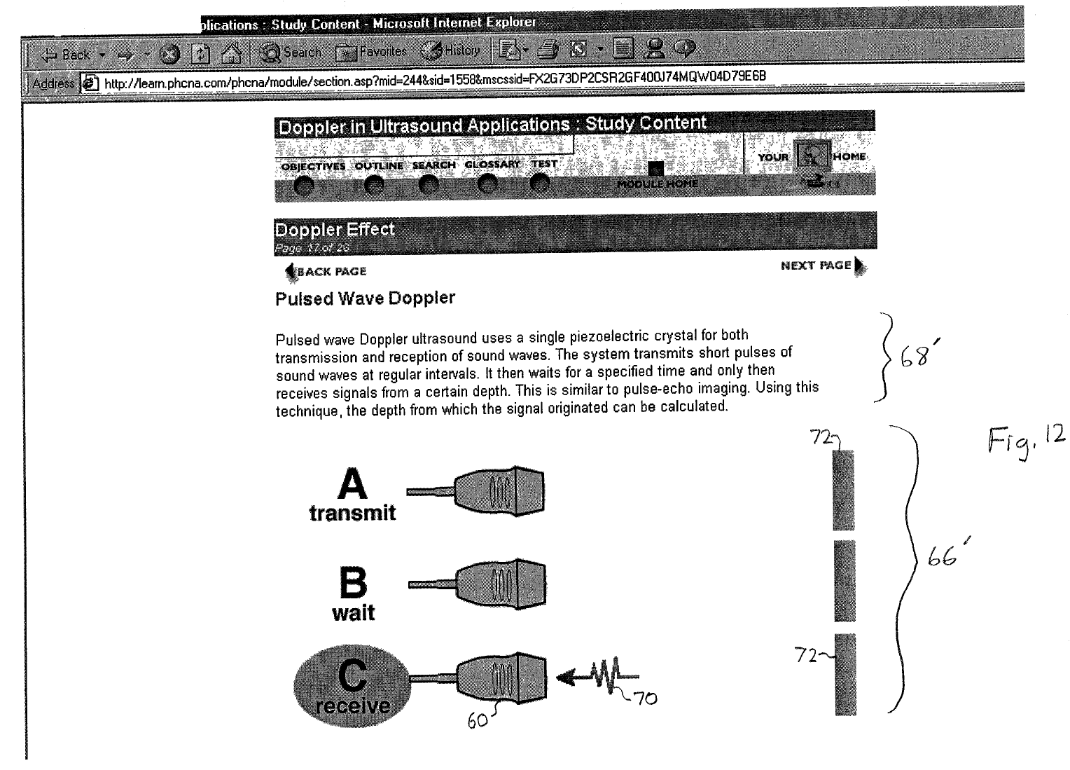

FIG. 12 is a scanned image of a display screen showing a second example of the text and animated graphics for the Doppler segment of the tutorial of the second embodiment of the present invention;

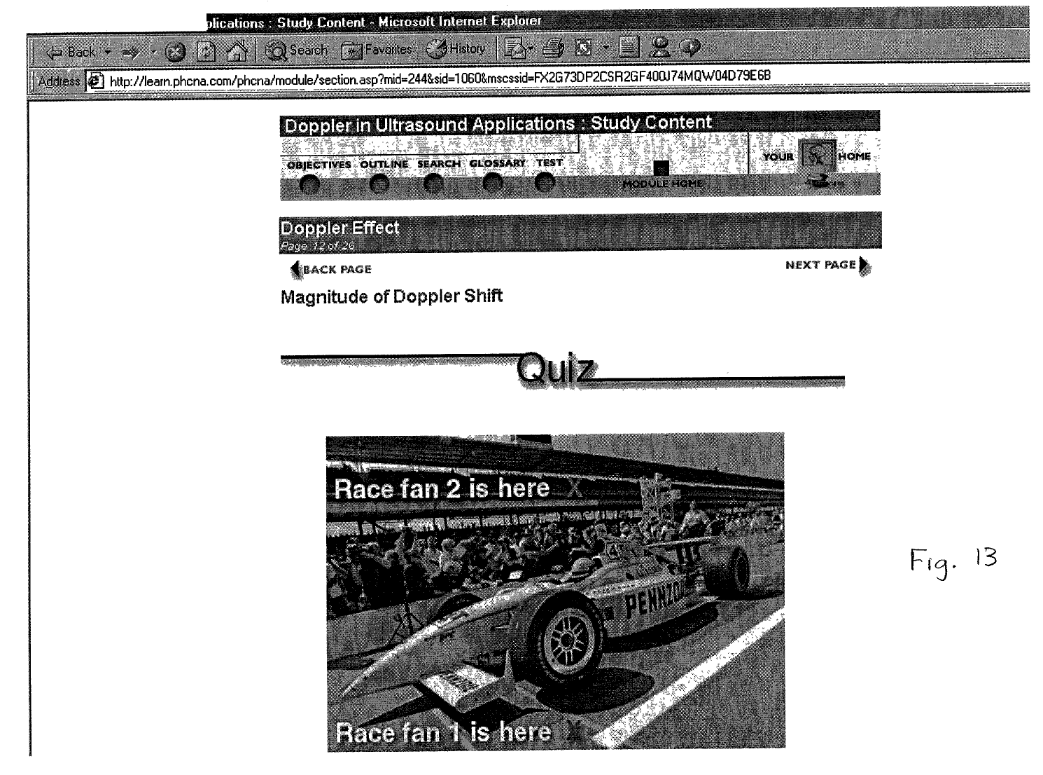

FIG. 13 is a scanned image of a display screen showing a first interactive quiz for the Doppler segment of the tutorial of the second embodiment of the present invention; and

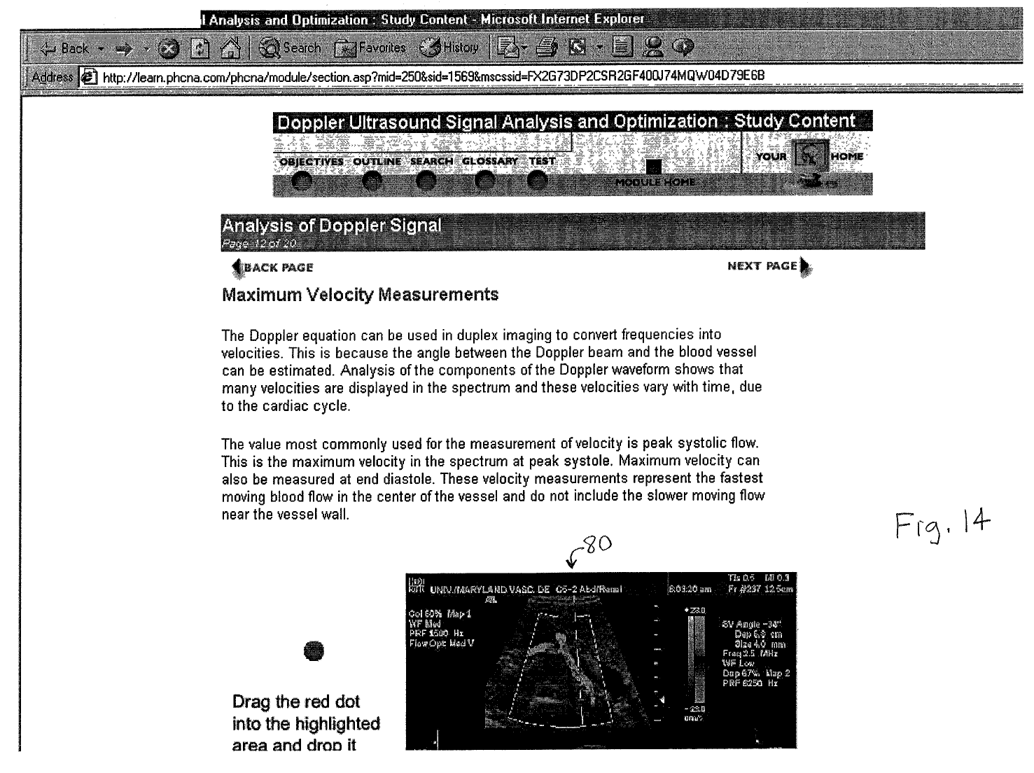

FIG. 14 is a scanned image of a display screen showing a second interactive quiz for the Doppler segment of the tutorial of the second embodiment of the present invention.

Referring first to FIG. 1, a flowchart of the progression of a computer-based medical case study training program organized in accordance with the principles of the present invention is shown. In this first embodiment the student is being trained to diagnose a particular medical condition or pathology. The information being taught is presented as a case study of a hypothetical patient with the particular condition. In a constructed embodiment, the medical data on the unnamed hypothetical patient is comprised of actual patient data from real patients and their conditions. In the first step 10 the student selects a particular case study of interest. The student may select a vascular study, a renal study, or a cardiac study, for example. When the student selects the case study of interest, the student is presented in step 12 with a virtual patient chart for the hypothetical patient. The patient chart is a medical record file familiar to most medical professionals. Hence, the student views the course information in a format with which he or she is familiar and uses on a daily basis in his or her medical practice. In step 14 the student selects the patient's medical records from the virtual patient chart. In this step the student learns the medical history of the patient, sees the examinations which the patient has undergone, and the medications and treatments which the patient has received in the past.

A purpose of this first embodiment of the present invention is to instruct the student on the full range of diagnostic procedures which may be useful in diagnosing the hypothetical patient's condition. In the illustrated embodiment to follow, reports of diagnostic imaging procedures from a wide range of different imaging modalities are accessible by the student. This is accomplished by allowing the student to access different diagnostic imaging reports from the virtual patient chart. In step 16 the student selects one of the diagnostic reports, learns whether a particular diagnostic imaging procedure is applicable for diagnosis of the patient's condition and, if so, the conclusions of the report. While diagnostic reports are commonly found in a patient chart, the illustrated embodiment also provides the student with information not normally contained in a patient chart. In this way the teaching experience of the student is enhanced with other instructive information and background material which will help the student form the proper diagnosis for the hypothetical patient. The flowchart shows two types of ancillary information upon which the student can draw to make a diagnosis. In step 22 the student is enabled to access laboratory reports and pictures such as pathology reports and specimen pictures of the pathology in question. The student is also given access, as shown in step 24, to a pathology library where the student can learn basic scientific and medical facts about the pathology in question.

After studying this material, the student may select another imaging modality and study the information provided by the diagnostic reports and ancillary material of the other modality, if applicable to the patient's condition, as shown at step 26. At any point in the course the student may feel that he or she has learned the subject matter of the particular case study sufficiently to form a diagnosis and thereupon can go to a test on the case study at step 20. In a computer-based embodiment the test is scored automatically and immediately and immediate feedback on the effectiveness of the learning experience is provided to the student.

FIGS. 2-8 illustrate a case study training program organized in accordance with the principles of the present invention. This illustrated embodiment is a training program with case studies which, when completed, provide the student with continuing education credits needed to maintain the credentials of a sonographer. The illustrated program is available to sonographers everywhere over the Internet as Web pages, enabling sonographers to obtain continuing education credits from the comfort of their own labs and offices using a standard Web browser. In the scanned image of FIG. 2 the student is presented with a choice of two vascular case studies, one for a carotid body tumor condition and another for a popliteal artery false aneurysm condition. The student clicks the desired case study and is presented with the scanned image of FIG. 3.

FIG. 3 shows the subject matter of the case study arranged as the student may find it in his or her clinical practice, in the form or a patient chart. Thus, the patient chart format of the case study presents the course material in a form which is familiar to the student, who would be a sonographer in this example. FIG. 3 illustrates the instructions given to the student to analyze the case study and the objectives of the training program. This page tells the student what he or she will learn during the course and how to navigate through the case study. When the student believes he or she has sufficiently analyzed the patient's condition and diagnostic reports contained in the case study, the student can click the “Test” button at the bottom of this and every other screen, and can take the test to complete the training program and receive the corresponding educational credits.

Arrayed across the top of the virtual patient record at 30 are a number of tabs. The student clicks on these tabs to access the indicated subject matter. In this embodiment the training program teaches the use of a number of imaging modalities to analyze a specific pathology, in this case, a carotid body tumor. The patient record presents reports and images on this pathology which have been acquired by modalities such as nuclear medicine, X-ray, MRI, angiography, ultrasound, and computed tomography. Thus the user learns how these different modalities may be useful in diagnosing the pathology of the case study.

Usually a patient chart will only contain summary information on the patient and his or her tests and reports. However, in order to provide a more complete learning experience, the virtual patient chart incorporates information not generally found in an actual patient chart, such as diagnostic images and general medical information about the pathology in question. Subsequent Web pages will illustrate how the student can access these ancillary materials during the training program.

When the student clicks on the Medical Records tab 32, the medical background of the hypothetical patient is presented as illustrated in FIG. 4. This general information may also include a description of the tests performed on the hypothetical patient and the patient's medications as illustrated by this page.

FIG. 5 illustrates the Web page displayed when the student selects the Angiography tab 34. This embodiment shows a typical angiography report as may be found in an actual patient chart, as well as more detailed diagnostic information not generally found in a summary report such as the angiographic images which are the subject of the angiography report.

If the student clicks on the X-ray or MRI tabs, the user will find no diagnostic information. Instead, the user will learn that X-ray and MRI were not utilized in this particular case, or are not appropriate diagnostic procedures for this particular pathological condition, an important part of the learning process.

FIG. 6 illustrates another type of medical information which is found in the hypothetical patient chart but is not usually present in an actual patient chart. In FIG. 6 the user has clicked the Laboratory/Pathology tab and has gained access to the hypothetical patient's pathology report and other laboratory reports such as blood and urinalysis tests. The reports used in the case study contain information such as actual specimen pictures of the pathology in question.

When the student clicks on the View Library tab 38 access is gained to general medical information about the pathology in question such as that shown in FIG. 7. This section of the virtual patient chart, not generally found in an actual patient chart, provides background information which is helpful for the student who is studying the particular pathology of the case study for the first time. This section can describe typical findings for the pathology, as well as signs, symptoms, treatments and prognosis for the particular pathological condition.

At any time during the case study the student can click the “Test” button 40 and be taken to the test page as shown in FIG. 8. Here the student will answer test questions to test his or her knowledge of what was learned. When the student has completed the test it is immediately scored automatically and the score displayed to the student. For a course providing credits for a certifying body such as this example, the student will generally print out a certificate of successful completion of the course, which can be sent to the accrediting body to maintain the student's professional certification.

The organization of another computer-based training program in accordance with the principles of the present invention is illustrated by the flowchart of FIG. 9. The format of this second embodiment is useful for courses teaching scientific principles or medical practices, or the operation of medical equipment, for example, which are referred to generally herein as tutorials. In this format, the student is exposed to subtopics or segments of the subject of the course, and tested periodically following the segments to check that learning is successful before additional subtopics are presented. Following the flowchart, the student begins the tutorial at step 50. When the student encounters a new segment in the training program the student will read about a scientific principle, medical practice, or equipment operating procedure as shown in step 52. Not only will the student read about the subtopic, but the student will also view an animated graphic or motion picture which illustrates the operation or effect of the principle, practice, or device being taught, as shown in step 54. With the learning reinforced by this active visual effect, the student is then presented a quiz on the learning segment as shown in step 56. In the illustrated embodiment to follow, the student is presented with an interactive quiz which goes beyond merely selecting or typing in a textual answer to a question. Once the quiz is completed, the student advances to the lesson of the next segment of the tutorial and learns about another principle, practice, or device operation. In a alternative embodiment of the present invention, if the student does not pass the quiz, the student could be taken back to the beginning of the segment to repeat the learning of the segment. When the student has finished the last lesson or segment of the tutorial, the course is completed as indicated at step 58.

An example of a segment of a tutorial organized in accordance with the principles of the present invention is illustrated in FIGS. 10-14. As with the case study illustrated above, this is a Web-based embodiment which can be made available and accessed locally or over a network such as the Internet. This embodiment could serve as a segment of a tutorial for training a sonographer on the use of an ultrasound system in the Doppler mode, or for general training in the principles of Doppler ultrasound. The first Web page shown in FIG. 10 is the introduction page for a tutorial segment on applications of the Doppler principle in ultrasound.

FIG. 11 is a scanned image of a Web page which teaches an application of the Doppler principle in ultrasound. In the prior art, tutorials have generally been long pages of text with an occasional picture or illustration. The student was required to read a lengthy text passage which could not fit on the screen, and would have to scroll down the page as he read. Such a presentation was generally tedious and abstract, and often failed to convey an intuitive sense of the principle being taught. In accordance with the principles of the present invention the tutorial contains an animated image which illustrates the principle being taught. The embodiment of FIG. 11 contains a short textual passage 68 which describes the Doppler principle in words. Preferably the text passage 68 can be viewed in its entirety on the Web page without scrolling, as is the case of the illustrated passage 68. Below the text is an animated graphic 66. In the animation of the graphic, an ultrasound probe 60 moves horizontally along tissue 64. As the probe moves it sends out transmitted Doppler beams which are displayed as lines extending from the probe with arrows directed to the tissue. In response to each transmitted beam a return beam is received by the probe 60 with an arrow directed toward the probe. One such return beam 62 is shown in the drawing. As the probe moves along the tissue the beams begin to encounter blood vessels with moving blood cells (not shown) and the animation of the return beams are shown carrying Doppler waves. Thus, as the student reads about the Doppler effect and how it develops, he or she can visually see the effect in the animation. The animation in a given embodiment can be animated graphics as shown, or moving pictures, or a combination of the two, and is matched to the textual lesson being taught.

A second example of an animated tutorial Web page is shown in FIG. 12. In this example the textual portion 68′ of the page explains the operation of pulsed wave Doppler and the animated graphic at 66′ illustrates the effect visually. The probe at “A” initially transmits a Doppler wave to a target 72, then waits an appropriate time for a return wave 70, which is shown on its return trip to the probe 60 from the target 72. Once again the student is able to visually see the effect of the scientific principle of Doppler while reading about it.

In accordance with a further aspect of the present invention, the student is given a short quiz at the end of the segment of the tutorial which has just been taught. In the prior art, a long tutorial covering a number of points would be concluded with a comprehensive test at the end of the tutorial. Testing the student at the end of a segment validates the student's understanding of the principle just taught before the tutorial moves on to another teaching segment. Preferably the quiz is not simply selecting the answer for a multiple-choice question or typing in an answer to a question, but is an interactive visual quiz. FIG. 13 illustrates one such interactive quiz. In this quiz the student sees a moving race car and is asked to click on one of the two locations “X” where a race fan would be located to hear an increase in the frequency of the race car engine soundwave due to the Doppler effect. If the student clicks the correct race fan location for the described Doppler effect, the tutorial program will conclude that the Doppler lesson segment just taught has been correctly comprehended by the student.

FIG. 14 illustrates a second example of an interactive quiz on the Doppler effect, this time through student interaction with an actual ultrasound Doppler image 80. In this quiz the student is asked to identify a particular feature of the ultrasound image. The student does this by dragging the red dot to the left of the ultrasound image onto the specified feature of the image with a computer pointer such as a computer mouse. In this particular example the student is asked to identify the maximum blood flow region in the ultrasound image as measured by the Doppler effect. The student does this by dragging the dot onto the appropriate blood flow color in the dashed Doppler box in the ultrasound image. In a particular embodiment the diagnostic image 80 may be a static image or may be an animated, moving image such as an ultrasound Cineloop of images. When the student successfully completes the quiz question or questions at the end of a particular tutorial segment the student moves on to learn and be tested on the subject matter of another segment until the tutorial is completed.

What is claimed is:

1. A computer-based interactive medical training system comprising a case study presented in a computerized display in a virtual patient chart format for a patient exhibiting a given medical condition, wherein the virtual patient chart format simulates realistic aspects of a patient chart of medical records.

2. The computer-based interactive medical training system of claim 1, wherein the virtual patient chart further comprises diagnostic reports of a plurality of diagnostic imaging modalities.

3. The computer-based interactive medical training system of claim 2, wherein the diagnostic reports further comprise diagnostic reports on the given medical condition.

4. The computer-based interactive medical training system of claim 2, wherein the diagnostic reports further comprise diagnostic images from the plurality of diagnostic imaging modalities.

5. The computer-based interactive medical training system of claim 2, wherein the diagnostic reports further comprise instruction that a given diagnostic modality is not appropriate or deemed necessary to diagnose the given medical condition.

6. The computer-based interactive medical training system of claim 1, wherein the virtual patient chart further comprises general medical information on the given medical condition.

7. The computer-based interactive medical training system of claim 6, wherein the general medical information further comprises one or more of typical findings for a given pathology, signs, symptoms, treatment and prognosis for the given medical condition.

8. The computer-based interactive medical training system of claim 1, wherein the virtual patient chart further comprises at least one of laboratory reports and pathology specimen pictures.

9. The computer-based interactive medical training system of claim 1, further comprising a test on the comprehension or application of the information of the virtual patient chart.

10. The computer-based interactive medical training system of claim 9, wherein the test comprises a test which may be taken following review of some or all of the material of the virtual patient chart.

11. The computer-based interactive medical training system of claim 9, wherein the virtual patient chart is presented by a computer, and wherein the test is scored by the computer presenting the patient chart.

12. The computer-based interactive medical training system of claim 9, wherein the virtual patient chart is presented by a computer, and wherein the test is scored by a computer connected to the computer presenting the patient chart.

13. A computer-based interactive medical training system comprising a tutorial presented in a computerized display, the tutorial presenting one or more teaching segments of medical information which contain an animation illustrating the medical information being taught.

14. The computer-based interactive medical training system of claim 13, wherein a teaching segment further comprises a textual passage describing the medical information and an animation illustrating the medical information.

15. The computer-based interactive medical training system of claim 14, wherein the animation comprises an animated graphic.

16. The computer-based interactive medical training system of claim 14, wherein the animation comprises a moving picture.

17. The computer-based interactive medical training system of claim 14, wherein the textual passage and the animation can be seen on a computer screen without scrolling.

18. The computer-based interactive medical training system of claim 13, wherein a teaching segment further comprises a quiz of the medical information taught in the segment.

19. The computer-based interactive medical training system of claim 18, wherein the number of teaching segments is two or more.

20. The computer-based interactive medical training system of claim 18, wherein the quiz further comprises a graphic with which a student interacts to demonstrate knowledge of the medical information.

21. The computer-based interactive medical training system of claim 20, wherein the graphic comprises a diagnostic medical image.

22. The computer-based interactive medical training system of claim 13, wherein the medical information comprises a clinical application of medical diagnostic imaging.

23. The computer-based interactive medical training system of claim 13, wherein the medical information comprises at least one of a scientific principle, medical practice, or operation of medical equipment.
